(19) United States
(12) Patent Application Publication
(10) Pub. No.: US 2013/0211848 A1
(43) Pub. Date: Aug. 15, 2013

(54) User interface for collecting association information

(71) Applicant: Steven Elliot Stupp, San Carlos, CA (US)

(72) Inventor: Steven Elliot Stupp, San Carlos, CA (US)

(21) Appl. No.: 13/507,889

(22) Filed: Aug. 2, 2012

Related U.S. Application Data
(60) Provisional application No. 61/574,556, filed on Aug. 3, 2011.

(51) Int. Cl. G06F 19/00

(52) U.S. Cl. CPC G06F 19/3431
USPC 705/2

(57) ABSTRACT

After receiving information specifying an occurrence of a temporal onset of an episodic manifestation of a chronic disease in an individual during a time interval, a question and associated categorical answers about exposure of the individual to a potential trigger of the episodic manifestation are provided. Note that the categorical answers include time intervals, and both the time interval and the time intervals correspond to a first temporal sampling rate. If an answer to the question specifies one of the time intervals that is the same as the time interval, another question and additional associated categorical answers about the exposure of the individual to the potential trigger of the episodic manifestation are provided. These additional categorical answers include additional time intervals corresponding to a second temporal sampling rate, which may be within the time interval, and which allows a causal relationship between the exposure to the potential trigger and the occurrence of the temporal onset to be specified.

### CROSS REFERENCE TO RELATED APPLICATIONS

This application claims priority under 35 U.S.C. 119(e) to U.S. Provisional Application Ser. No. 61/574,556, “User Interface for Collecting Association Information,” filed on Aug. 3, 2011, the contents of which are herein incorporated by reference.

### FIELD

The present disclosure relates generally to an apparatus, a user interface and related methods for collecting information about a disease for subsequent analysis.

### BACKGROUND

The analysis of data to determine statistical associations is often gated by the quality of the data. In particular, if collected data is inaccurate or noisy, it can be difficult or even impossible to subsequently analyze this data to accurately determine statistical associations.

However, collecting data from human subjects can be particularly difficult. For example, many aspects of human behavior are associated with short time-scale neurological responses. High sampling rates are often needed in order to capture these events accurately. In turn, the high sampling rates often result in the collection of a significant amount of information. In the case of a subject questionnaire, this usually results in a large number of questions, which can be time consuming and annoying for the subjects to answer. As a consequence, the subjects may not answer the questions or may answer the questions in a hap-hazard or sloppy fashion, thereby degrading the quality of the collected data and potentially adversely impacting any subsequent statistical analysis.

Similarly, many human activities have a wide range of variations on a common theme, which can be difficult to capture in a succinct manner. For example, there are often a large number of permutations on the dishes that people eat. Explicitly including all of these permutations can result in a very large number of potential answers that subjects may need to sort through when answering questions about their dietary habits. This can be time consuming and annoying for the subjects. Thus, this approach to data collection may also result in questions that are not answered or hap-hazard or sloppy answers, which can also degrade the quality of the collected data and potentially adversely impact any subsequent statistical analysis.

Hence, what are needed are a user interface and a technique for collecting information without the preceding problems.

### SUMMARY

The disclosed embodiments relate to a computer system that collects information associated with a chronic disease having episodic manifestations. During operation, the computer system receives information specifying an occurrence of a temporal onset of an episodic manifestation of the chronic disease in an individual during a time interval, where the time interval corresponds to a first temporal sampling rate. Then, the computer system provides a question and associated categorical answers about exposure of the individual to a potential trigger of the episodic manifestation, where the categorical answers include time intervals corresponding to the first temporal sampling rate. Moreover, the computer system receives an answer to the question, where the answer specifies at least one of the time intervals. If the time interval and at least the one of the time intervals are the same, the computer system provides another question and additional associated categorical answers about the exposure of the individual to the potential trigger of the episodic manifestation. Note that the additional categorical answers include additional time intervals corresponding to a second temporal sampling rate, which may be within the time interval, and the additional categorical answers specify a causal relationship between the exposure of the individual to the potential trigger of the episodic manifestation and the occurrence of the temporal onset of the episodic manifestation of the chronic disease in the individual. Next, the computer system receives another answer to the other question, wherein the other answer specifies at least one of the additional time intervals.

Note that the episodic manifestation may include: a type of headache, a seizure, dyspnea, increased pain, a reduction in mobility, cancer, a change in blood sugar level, use of an addictive substance, occurrence of mental illness, weight change, diarrhea, abdominal cramps, abdominal pain, arteriosclerosis, a heart attack, and/or change in renal function. Moreover, the chronic disease may include: migraine headache, tension headache, epilepsy, pulmonary disease, asthma, arthritis, cancer, diabetes, addiction, a psychiatric disorder, an eating disorder, gastrointestinal disease, cardiovascular disease, renal disease, and/or obesity.

Furthermore, the time intervals may include: morning, afternoon, evening and night. Thus, the first temporal sampling rate may include every 6 hours. This first temporal sampling rate may be smaller than the second temporal sampling rate.

Additionally, the additional time intervals may include: a time interval preceding the temporal onset; and a time interval after the temporal onset. Alternatively, the additional time intervals may include: a time interval more than a time duration (such as one hour) preceding the temporal onset; a time interval less than the time duration preceding the temporal onset; and a time interval after the temporal onset.

Note that the potential trigger of the episodic manifestation may include a neurological trigger that is neurologically sensed by the individual on a time scale within the time interval.

In another embodiment, the computer system collects dietary information, which may or may not be associated with the episodic manifestations of the chronic disease. During operation, the computer system receives information associated with a dietary item consumed by an individual during a time interval. Then, the computer system determines that there are multiple potential variations on the ingredients in the dietary item. In response, the computer system provides a list of potential ingredients in the dietary item. Moreover, the computer system receives information specifying at least one of the potential ingredients in the list, thereby specifying one of the ingredients in the dietary item.

Note that the potential ingredients in the list may be selectable (such as check boxes in a user interface). Furthermore, the time interval may include a portion of a day, such as: morning, afternoon, evening or night. Alternatively, the time interval may include a meal.

Additionally, the potential ingredients may include toppings. In some embodiments, the dietary item includes: a type of dessert, an omelette, a pancake, a pizza, a brownie, and/or a cup of coffee.

Moreover, the list of potential ingredients may be provided instead of providing the permutations and combinations of the potential ingredients in the dietary item, thereby simplifying the collection of the dietary information.

Another embodiment provides a method that includes at least some of the operations performed by the computer system in either of the preceding embodiments.

Another embodiment provides a computer-program product for use with the computer system. This computer-program product includes instructions for at least some of the operations performed by the computer system in either of the preceding embodiments.

Another embodiment provides a user interface for displaying information provided by the computer system in either of the preceding embodiments.

### BRIEF DESCRIPTION OF THE DRAWINGS

FIG. 1 is a flow diagram illustrating a method for collecting information associated with a chronic disease having episodic manifestations in accordance with an embodiment of the present disclosure.

FIG. 2 is a flow diagram illustrating the method of FIG. 1 in accordance with an embodiment of the present disclosure.

FIG. 3 is a block diagram illustrating a user interface during the method of FIG. 1 in accordance with an embodiment of the present disclosure.

FIG. 4 is a flow diagram illustrating a method for collecting dietary information in accordance with an embodiment of the present disclosure.

FIG. 5 is a flow diagram illustrating the method of FIG. 4 in accordance with an embodiment of the present disclosure.

FIG. 6 is a block diagram illustrating a user interface during the method of FIG. 4 in accordance with an embodiment of the present disclosure.

FIG. 7 is a block diagram illustrating an embodiment of a system that performs the methods of FIGS. 1 and/or 4 in accordance with an embodiment of the present disclosure.

FIG. 8 is a block diagram illustrating a computer system that performs the methods of FIGS. 1 and/or 4 in accordance with an embodiment of the present disclosure.

FIG. 9 is a block diagram illustrating a data structure for use in the computer system of FIG. 8 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a user interface, a technique for collecting information, and an associated computer-program product (e.g., software) for use with the computer system are described. During the collection technique, after receiving information specifying an occurrence of a temporal onset of an episodic manifestation of a chronic disease in an individual during a time interval, a question and associated categorical answers about exposure of the individual to a potential trigger of the episodic manifestation are provided. Note that the categorical answers include time intervals, and both the time interval and the time intervals correspond to a first temporal sampling rate. If an answer to the question specifies one of the time intervals that is the same as the time interval, another question (which is sometimes referred to as a ‘dependent question’) and additional associated categorical answers about the exposure of the individual to the potential trigger of the episodic manifestation are provided. These additional categorical answers include additional time intervals corresponding to a second temporal sampling rate, which may be within the time interval, and which allows a causal relationship between the exposure to the potential trigger and the occurrence of the temporal onset to be specified.

By allowing the causal relationship to be specified using a dependent question, the collection technique provides subject questionnaires with fewer questions that can accurately sample the exposure to the potential trigger. In this way, the collection technique can result in simpler questionnaires that are easier and less time consuming to answer. As a consequence, questions in the questionnaires are more likely to be answered and the answers are more likely to be accurate. In conjunction with the causal subsampling provided by the dependent question, this collection technique may improve the accuracy of a statistical association between the potential trigger and the occurrence of the temporal onset that can be determined in subsequent analysis of the collected information.

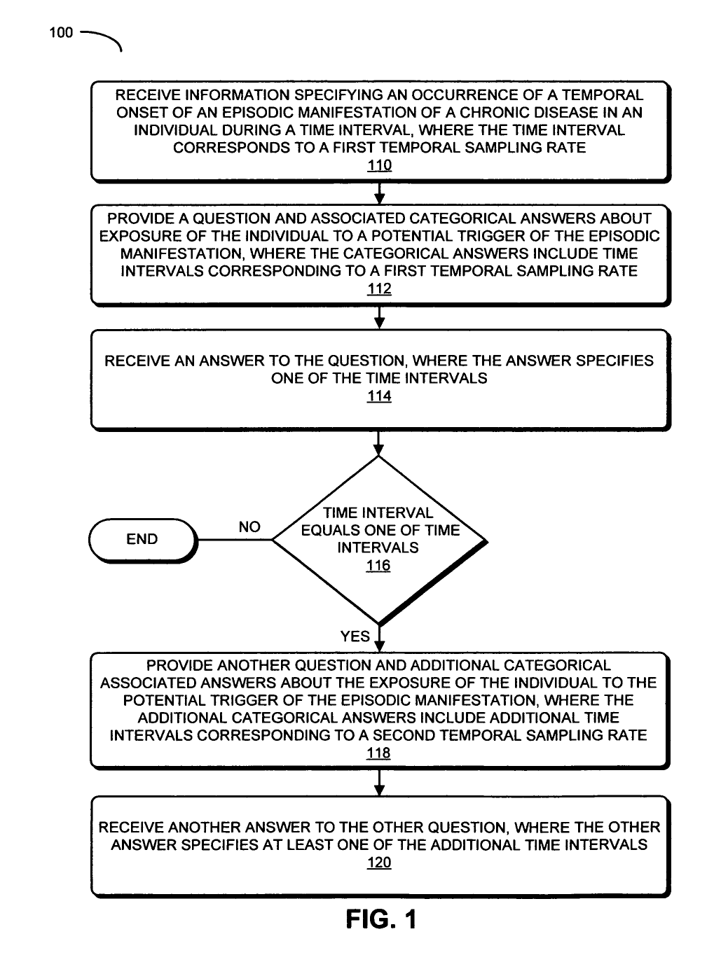

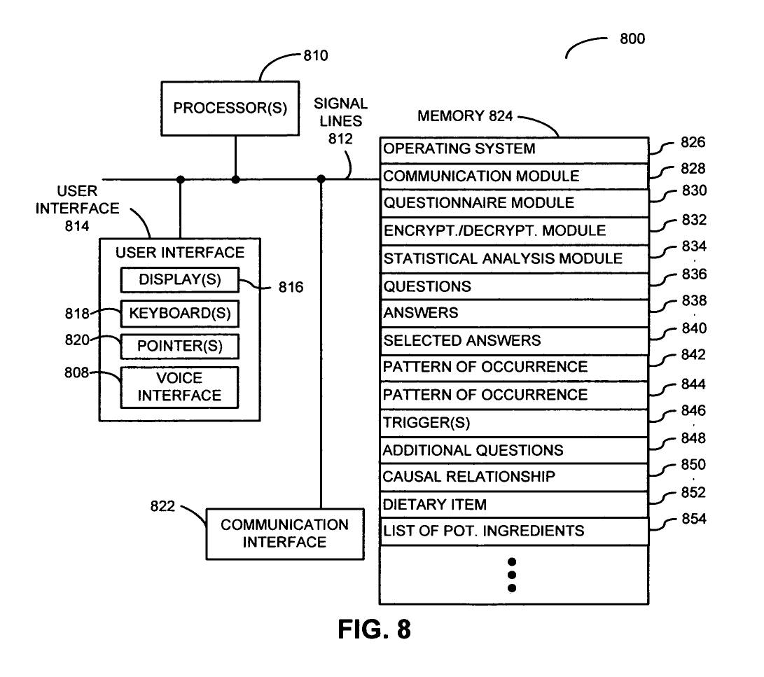

We now describe embodiments of the collection technique and the associated user interface. FIG. 1 presents a flow diagram illustrating a method 100 for collecting information associated with a chronic disease having episodic manifestations, which may be performed by computer system 800 (FIG. 8). During operation, the computer system receives information specifying an occurrence of a temporal onset of an episodic manifestation of the chronic disease in an individual during a time interval (operation 110), where the time interval corresponds to a first temporal sampling rate. For example, the time interval may be morning, afternoon, evening or night. Alternatively, the time interval may include a time (or time stamp) during the time interval. (Thus, the time interval may have zero or finite duration.)

Note that the episodic manifestation may include: a type of headache (such as a migraine or a tension headache), a seizure, dyspnea, increased pain, a reduction in mobility (for example, due to arthritis), cancer, a change in blood sugar level, use of an addictive substance, occurrence of mental illness, weight change, diarrhea, abdominal cramps, abdominal pain, arteriosclerosis, a heart attack, and/or change in renal function. More generally, the episodic manifestation may correspond to an episodic increase in a severity of one or more symptoms associated with a medical condition, a disease, such as a chronic disease, and/or a disease condition in at least one individual.

Moreover, the chronic disease may include: migraine headache, tension headache, abdominal migraines, cyclic vomiting syndrome, cluster headaches, chronic headaches, another type of headache, epilepsy, seizures, pulmonary disease, asthma, a form of arthritis (such as rheumatoid arthritis), a type of cancer, diabetes, addiction, a psychological or psychiatric disorder (such as depression), an eating disorder, gastrointestinal disease (such as colitis, ulcerative colitis, inflammatory bowel disease, Crohn's disease, candida, celiac disease, irritable bowel syndrome, etc.), cardiovascular disease (such as heart disease), renal disease, a joint disease, an auto-immune disorder, an immune-related disorder, an inflammatory disease, lupus, thyroid disease, gout, chronic fatigue syndrome, insomnia, one or more food allergies, one or more food sensitivities, morning sickness, menstrual cramps, chronic pain, back pain, facial pain, fibromyalgia, neurodermatitis, acne, psoriasis, hypertonia, hypertension, arteriosclerosis, acquired immune deficiency syndrome and/or obesity.

Then, the computer system provides a question and associated categorical answers about exposure of the individual to a potential trigger of the episodic manifestation (operation 112), where the categorical answers include time intervals corresponding to the first temporal sampling rate. For example, the time intervals may include: morning, afternoon, evening and night. Thus, the first temporal sampling rate may include every 6 hours.

Moreover, the computer system receives an answer to the question (operation 114), where the answer specifies at least one of the time intervals. If the time interval and at least the one of the time intervals are the same (operation 116), the computer system provides another question and additional associated categorical answers about the exposure of the individual to the potential trigger of the episodic manifestation (operation 118). Note that the additional categorical answers include additional time intervals corresponding to a second temporal sampling rate, which may be within the time interval (thus the first temporal sampling rate may be smaller than the second temporal sampling rate), and the additional categorical answers specify a causal relationship between the exposure of the individual to the potential trigger of the episodic manifestation and the occurrence of the temporal onset of the episodic manifestation of the chronic disease in the individual. For example, the additional time intervals may include: a time interval preceding the temporal onset; and a time interval after the temporal onset. Alternatively, the additional time intervals may include: a time interval more than a time duration (such as one hour) preceding the temporal onset; a time interval less than the time duration preceding the temporal onset; and a time interval after the temporal onset.

Next, the computer system receives another answer to the other question, wherein the other answer specifies at least one of the additional time intervals (operation 120).

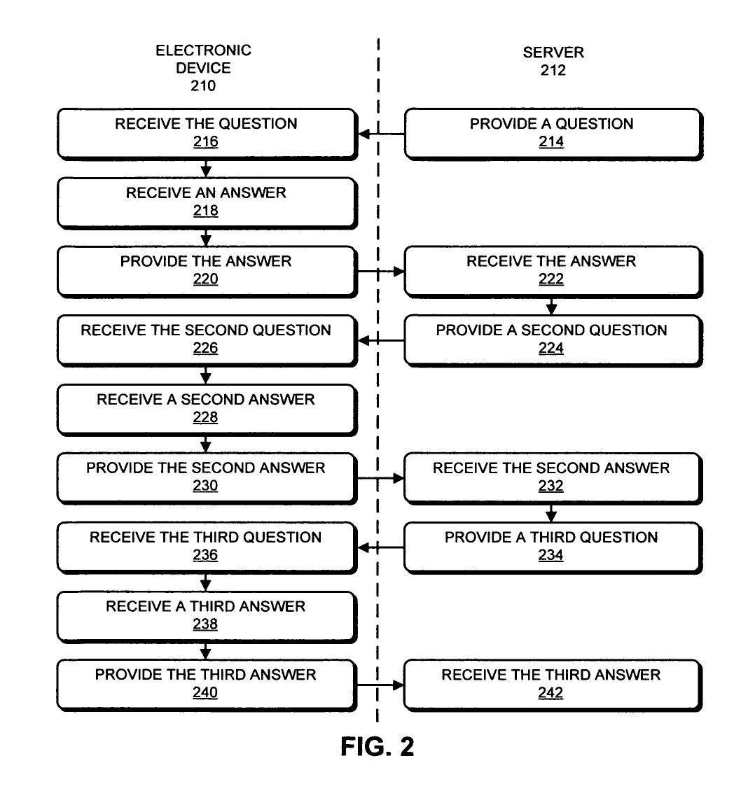

In an exemplary embodiment, the collection technique is implemented using an electronic device (such as a client computer or a portable electronic device) and at least one server, which communicate through a network, such as the Internet (i.e., using a client-server architecture). This is illustrated in FIG. 2, which presents a flow chart illustrating method 100. During this method, server 212 provides a question (operation 214) asking if a temporal onset of an episodic manifestation of a chronic disease occurred during a time interval. Electronic device 210 may receive the question (operation 216) and may receive a user answer (operation 218) which indicates that an episodic manifestation occurred. This answer may be provided to (operation 220) and received by (operation 222) server 212.

Then, server 212 may provide a second question and associated categorical answers (operation 224) about exposure of the individual to a potential trigger of the episodic manifestation. Electronic device 210 may receive the second question (operation 226) and may receive a second user answer (operation 228) which indicates that exposure occurred during the time interval. This second answer may be provided to (operation 230) and received by (operation 232) server 212.

If a time interval specified in the answer and a time interval specified in the second answer are the same, server 212 may provide a third question and additional associated categorical answers (operation 234) to assess a causal relationship between the exposure and the temporal onset. Electronic device 210 may receive the third question (operation 236) and may receive a third user answer (operation 238) which indicates that causal relationship. This third answer may be provided to (operation 240) and received by (operation 242) server 212.

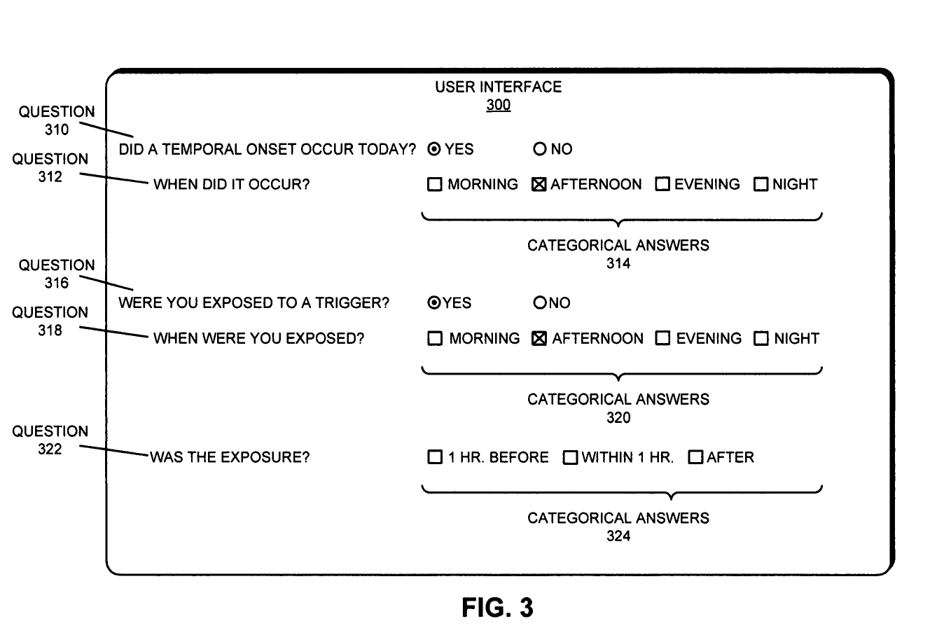

FIG. 3 presents a block diagram illustrating a user interface 300 during method 100 (FIG. 1). In this user interface, a user of an electronic device (such as computer system 800 in FIG. 8) that displays user interface 300 may be asked if a temporal onset of an episodic manifestation of the chronic diseases occurred during a given day in question 310. If the user answers ‘yes,’ the user may be asked when the temporal onset occurred in question 312, and the user may be provided with a set of time intervals (such as ‘morning’ or 6 am-12 pm, ‘afternoon’ or 12 pm-6 pm, ‘evening’ or 6 pm-12 am, and ‘night’ or 12 am-6 am) as categorical answers 314 from which to choose.

Subsequently, the user may be asked if they were exposed to a potential trigger of the episodic manifestation in question 316. If yes, the user may be may be asked when in question 318 and provided with a set of time intervals (such as ‘morning’ or 6 am-12 pm, ‘afternoon’ or 12 pm-6 pm, ‘evening’ or 6 pm-12 am, and ‘night’ or 12 am-6 am) as categorical answers 320 from which to choose. Note that the temporal sampling rate of categorical answers 314 and 320 (every 6 hours) is the same. (While a 6-hour sampling rate is used as an illustrative example, in other embodiments the sampling rate may be larger or smaller.)

If at least one of the specified time intervals in response to questions 312 and 318 are the same (such as ‘afternoon’), the user may be asked an additional question to determine whether the exposure of the user to the potential trigger of the episodic manifestation was causal or on a time scale that is relevant for a neurological trigger. In particular, in question 322 the user may be asked whether the exposure was during one of a set of time intervals (such as a time interval more than one hour preceding the temporal onset, a time interval less than one hour preceding the temporal onset, and a time interval after the temporal onset) as categorical answers 324. (Once again, while a 1-hour subsampling rate is used as an illustrative example, in other embodiments the subsampling rate may be larger or smaller.) Note that the temporal sampling rate of categorical answers 324 is larger than that of categorical answers 314 and 320. As a consequence, categorical answers 324 may be within the common time interval specified in response to questions 312 and 318. Thus, by specifying one of categorical answers 324, the user can specify a causal relationship between the exposure of the user to the potential trigger of the episodic manifestation and the occurrence of the temporal onset of the episodic manifestation of the chronic disease in the user.

As noted previously, this approach to subsampling in the collection technique may simplify a user questionnaire that includes questions 310, 312, 316, 318 and 322, improving the accuracy of the answers and, thus, eventual statistical analysis of the pattern of answers to the these questions (including presence and absence information) and a pattern of occurrence of the temporal onsets (including presence and absence information). For example, the patterns may be analyzed using a supervised learning technique (such as a parametric or a non-parametric supervised learning technique) determine statistical associations between the pattern of occurrence of exposure to the potential trigger and the pattern of occurrence of the temporal onsets. In some embodiments, the statistical associations are determined between a compound variable, which corresponds to patterns of occurrence of exposure to at least pairs of potential triggers (for example, the compound variable may be determined by performing a logical or Boolean operation, such as an AND operation, on entries in the patterns of occurrence of exposure to a pair of potential triggers), and the pattern of occurrence of the temporal onsets.

In this way, the collected information may be analyzed to identify potential triggers of the episodic manifestations (which are sometimes referred to as ‘association variables’). These potential triggers may be used to guide patient care (such as to recommend therapeutic interventions) and to improved patient outcomes and quality of life (for example, reducing the severity, frequency and/or duration of symptoms of a disease by assisting patients in avoiding their individual-specific triggers).

(Note that the one or more association variables may, at least in part, trigger, initiate, and/or precipitate one or more episodic manifestations, which is broadly referred to as a ‘trigger.’ Thus, one or more association variables may directly or indirectly cause the one or more events. Alternatively, the one or more association variables may not directly or indirectly cause the one or more episodic manifestations. Instead, the one or more association variables may enable the one or more episodic manifestations. To make an analogy, in some embodiments the one or more association variables may function as keys in one or more locks (such as receptors), allowing a spring-loaded door (corresponding, for example, to a biochemical predisposition or reaction) to open.)

In some embodiments, this subsampling approach may be useful in selectively obtaining additional information for potential triggers that operate on short time scales (such as during one of the time intervals in categorical answers 314 and 320). For example, some potential triggers, such as dietary items, are expected to operate on longer time scales (at least the 6-12 hours associated with digestion and absorption of the constituent ingredients in the dietary items). In contrast, a neurological trigger (such as a flashing light, a loud noise or a smell) that is neurologically sensed by a patient may occur on a short time scale, such as in minutes or up to an hour. If the user of the questionnaire were always asked to specify exposure (or consumption) of potential triggers at a temporal sampling rate consistent with the Nyquist sampling criterion for such a neurological phenomenon, the resulting questionnaire could be very complicated and difficult to use. Instead, the collection technique allows additional sampling (or subsampling) to occur as needed, thereby allowing causal relationships between the potential trigger and the temporal onset to be specified in an efficient manner.

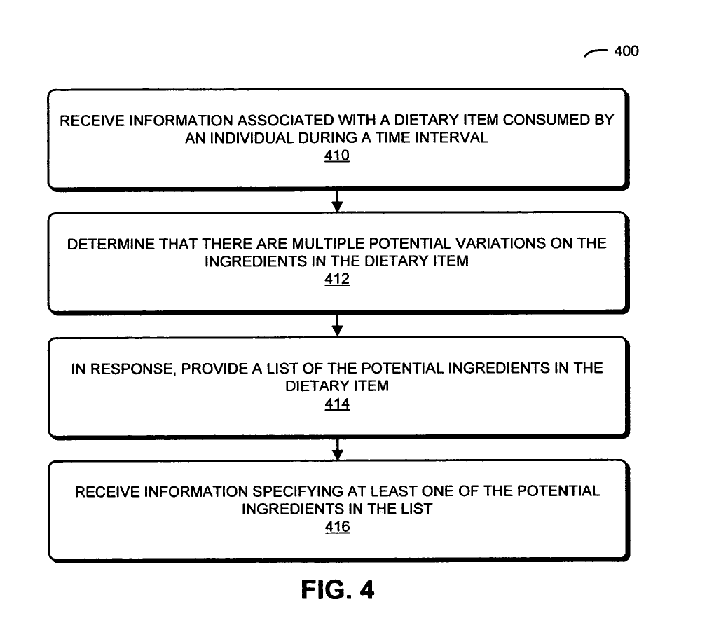

FIG. 4 presents a flow diagram illustrating a method 400 for collecting dietary information, which may be performed by computer system 800 (FIG. 8). This dietary information may or may not be associated with the episodic manifestations of the chronic disease. (Thus, method 400 may be used to collect dietary information from an arbitrary individual.) During operation, the computer system receives information associated with a dietary item consumed by an individual during a time interval (operation 410). This time interval may include a portion of a day, such as: morning, afternoon, evening or night. Alternatively, the time interval may include a meal. (Thus, the time interval may have zero or finite duration.) For example, the individual may indicate that they ate pizza for dinner. More generally, the dietary item may include: a type of dessert, an omelette, a pancake, a pizza, a brownie, and/or a cup of coffee.

Then, the computer system determines that there are multiple potential variations on the ingredients in the dietary item (operation 412). For example, the computer system may access a predefine data structure that is stored in a computer-readable memory to determine if there are multiple potential variations on the ingredients in the dietary item. As an illustration, the potential ingredients may include toppings on the pizza.

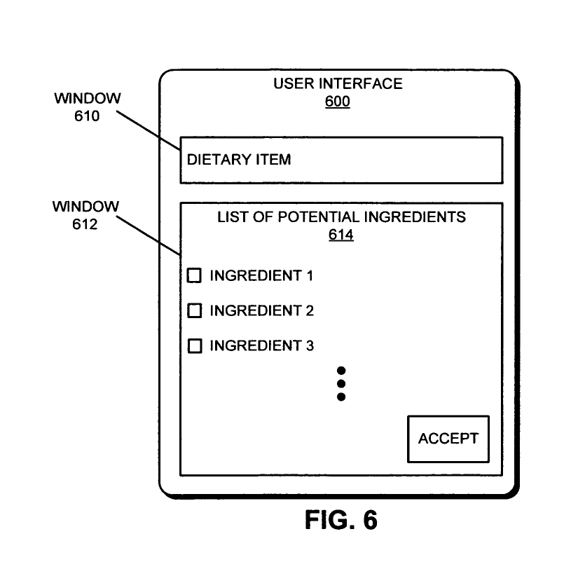

In response, the computer system provides a list of potential ingredients in the dietary item (operation 414). For example, as illustrated below with reference to FIG. 6, the potential ingredients in the list may be selectable (such as check boxes in user interface 600 in FIG. 6).

Moreover, the computer system receives information specifying at least one of the potential ingredients in the list (operation 416), thereby specifying one of the ingredients in the dietary item.

Note that the list of potential ingredients may be provided instead of providing the permutations and combinations of the potential ingredients in the dietary item. In this way, a questionnaire that collects the dietary information can be simplified, thereby improving the accuracy of the collected information and any subsequent statistical analysis (such as identification of the potential triggers).

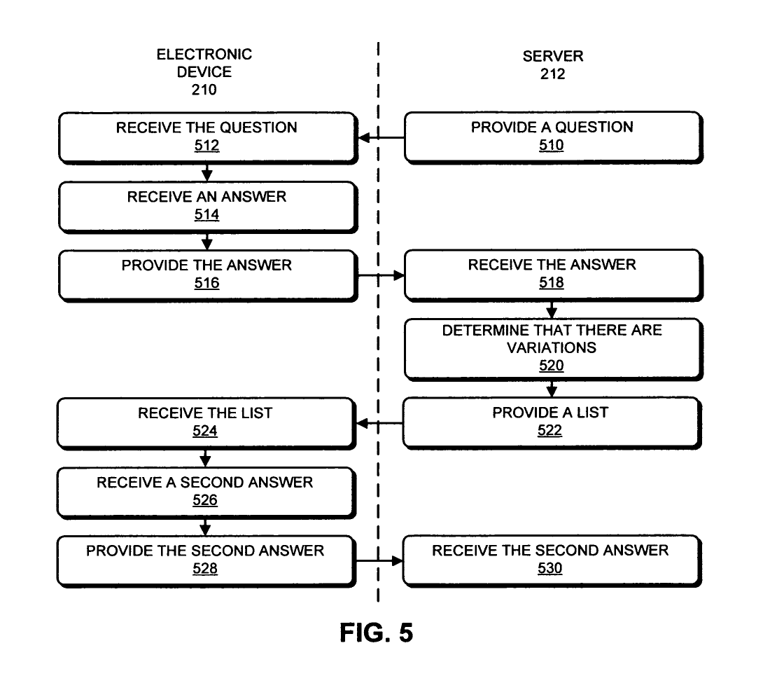

In an exemplary embodiment, the collection technique is implemented using an electronic device (such as a client computer or a portable electronic device) and at least one server, which communicate through a network, such as the Internet (i.e., using a client-server architecture). This is illustrated in FIG. 5, which presents a flow chart illustrating method 400. During this method, server 212 provides a question (operation 510) asking what a user ate during a meal. Electronic device 210 may receive the question (operation 512) and may receive a user answer which indicates that they ate a dietary item (operation 514). This answer may be provided to (operation 516) and received by (operation 518) server 212.

If it is determined (operation 520) that there are a number of variations on potential ingredients in the dietary item, server 212 may provide a list of potential ingredients (operation 522). Electronic device 210 may receive the list of potential ingredients (operation 524) and may receive a second user answer (operation 526) that indicates which, if any, of the potential ingredients were included in the dietary item. This second answer may be provided to (operation 528) and received by (operation 530) server 212.

In some embodiments of methods 100 (FIG. 1) and 400 (FIG. 4), there may be additional or fewer operations. For example, instead of specifying one of the time intervals in method 100 (FIG. 1), a user may specify a time. (Thus, the associated answers and/or the associated additional answers may or may not be categorical.) If this time is the same as or almost the same as (for example, within an hour or two of the time when the temporal onset occurred), the user may be asked the other question to specify the causal relationship. Moreover, the order of the operations may be changed, and/or two or more operations may be combined into a single operation.

FIG. 6 presents a block diagram illustrating a user interface 600 during method 400 (FIG. 4). In this user interface, a user may enter or indicate a dietary item (such as a food or beverage) that they previously consumed during a time interval (such as ‘morning’ or at breakfast) in window 610. If there are a number of potential ingredients in the dietary item (for example, as determined based on a predefined ingredient data structure that is stored in a computer-readable medium), rather than presenting all the possible permutations and combinations of these potential ingredients to the user as a large set of fixed dietary items, a list of potential ingredients 614 may be presented in window 612. As shown in FIG. 6, these potential ingredients in the dietary item may be selectable, such as check boxes. The user can selected those (if any) that are relevant, and then can activate an accept icon (by clicking or touching) to enter the selections, and thus to modify the ingredients in the dietary item.

For example, if the dietary item is a fruit pie, list of potential ingredients 614 may include: apple, cinnamon, rhubarb, apricot, blackberry, raspberry, and cherry. These selectable potential ingredients may allow the user to selectively supplement default ingredients that are typically included in a fruit pie, such as: butter or margarine, egg, flour, milk, salt, sugar and water.

Alternatively, if the dietary item is an omelette, list of potential ingredients 614 may include: American cheese, black pepper, cheddar cheese, cheese, green bell pepper, green onion, ham, hot pepper sauce, ketchup, lox, milk, mozzarella cheese, mushroom, onion, potato, red bell pepper, salt, Swiss cheese, and tomato. These selectable potential ingredients may allow the user to selectively supplement default ingredients that are typically included in an omelette, such as: butter or margarine, and egg.

In another example, if the dietary item is a pancake, list of potential ingredients 614 may include: apple, banana, blueberry, butter, chocolate chip, cinnamon, fruit, maple syrup, molasses, nutmeg, pancake syrup, raspberry, strawberry, vanilla extract and whipping cream. These selectable potential ingredients may allow the user to selectively supplement default ingredients that are typically included in a pancake, such as: baking powder, butter or margarine, egg, flour, milk, salt, and sugar.

In another example, if the dietary item is pizza, list of potential ingredients 614 may include: potato, provolone cheese, tomato, clam, pancetta, vegetarian cheese, anchovy, arugula, artichoke heart, bacon, banana pepper, basil, beef, bell pepper, black olive, broccoli, buffalo sauce, chicken, chile pepper, eggplant, feta cheese, green bell pepper, green olive, green onion, ham, hot Italian sausage, Italian meatball, linguica, mushroom, onion, parmesan cheese, pepperoni, pesto, pineapple, prosciutto, red onion, red pepper flake, ricotta cheese, roasted red bell pepper, roma tomato, romano cheese, salami, sausage, shrimp, spinach, sun dried tomato and zucchini. These selectable potential ingredients may allow the user to selectively supplement default ingredients that are typically included in a pizza, such as: baker's yeast, flour, garlic, mozzarella cheese, olive oil, basil, black pepper, oregano, onion, salt, sugar and tomato paste.

In another example, if the dietary item is a brownie, list of potential ingredients 614 may include: almond, butterscotch, chocolate, coconut, coffee, cream cheese, hazelnut, macadamia nut, maraschino cherry, marshmallow, peanut butter, pecan, walnut and white chocolate chips. These selectable potential ingredients may allow the user to selectively supplement default ingredients that are typically included in a brownie, such as: baking powder, butter, cream, egg, flour, milk, salt, sugar, vanilla, and whipping cream.

In yet another example, if the dietary item is a cup of coffee, list of potential ingredients 614 may include: artificial sweetener, coffee cream, Equal® (a trademark of the Merisant Company), lowfat milk, milk, non-dairy creamer, NutraSweet® (a trademark of the NutraSweet Company), Splenda® (a trademark of Tate and Lyle, PLC), sugar and Sweet'N Low® (a trademark of the Cumberland Packaging Corporation). These selectable potential ingredients may allow the user to selectively supplement default ingredients that are typically included in a cup of coffee, such as: coffee bean and water.

By compactly and efficiently allowing users to provide dietary items that they consumed, along with the appropriate ingredients, this collection technique may facilitate subsequent accurate determination of statistical associations between the ingredients in the dietary items and the pattern of occurrence of the temporal onsets (and, thus, identification of potential triggers of the episodic manifestations).

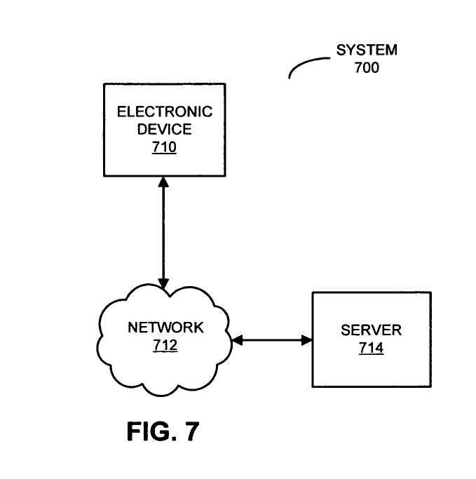

We now describe embodiments of a system and a computer system that perform either or both of the preceding methods. FIG. 7 presents a block diagram illustrating an embodiment of a system 700 that performs methods 100 (FIG. 1) and/or 400 (FIG. 4). In this system, a user of electronic device 710 (such as a personal computer) answers questions in an electronic questionnaire that collects information associated with user activities and behaviors, as well as episodic manifestations of a chronic disease (such as onsets of migraines experienced by the user). For example, the questionnaire may be included in a web page that is provided by server 714 via network 712, and which is rendered by a web browser on electronic device 710. Alternatively, the user may use a questionnaire application that is resident on and that executes on electronic device 710. This questionnaire application may be a standalone application or a portion of another application that is resident on and which executes on electronic device 710 (such as a medical application that is provided by server 714 or that is installed and which executes on electronic device 710). Consequently, in some embodiments the questionnaire application may operate independently of coupling to network 712.

In some embodiments, at least a portion of the questionnaire application may be an application tool (such as a questionnaire application tool) that is embedded in the web page (and which executes in a virtual environment of the web browser). Thus, the financial application tool may be provided to the user via a client-server architecture.

As discussed previously, while using the questionnaire application on electronic device 710, additional questions may be asked to specify a causal relationship between a given temporal onset that occurred in a time interval and exposure (or consumption) of a potential trigger (such as a food ingredient) during the same time interval. Alternatively, if the user reports that they consumed a particular dietary item that may include a variety of potential ingredients, the user may be prompted with a list of potential ingredients in the dietary item, thereby assisting the user in specifying what they ate.

Note that information in system 700 may be stored at one or more locations in system 700 (i.e., locally or remotely). Moreover, because this data may be sensitive in nature, it may be encrypted. For example, stored data and/or data communicated via network 712 may be encrypted.

FIG. 8 presents a block diagram illustrating a computer system 800 that performs methods 100 (FIG. 1) and/or 400 (FIG. 4), such as server 714 (FIG. 7). Computer system 800 includes one or more processing units or processors 810 (which are each a means for computing), at least one network or communications interface 822 to communicate with other computers, servers, devices, and/or databases, a memory 824 (which is a means for storage) with primary and/or secondary storage, at least one optional user interface 814, and one or more signal lines 812 for coupling or connecting these components. The one or more processors 810 may support parallel processing and/or multi-threaded operation. Moreover, the optional user interface 814 may include: one or more displays 816, keyboards 818, pointers 820 (such as a mouse), a touchpad (not shown), and/or a voice interface 808, including one or more speakers and/or microphones. The one or more displays 816 may include a touch screen (which may combine the functionality of at least one of the keyboards 818 with at least one of the displays 816). Furthermore, the one or more signal lines 812 may constitute one or more communication buses and/or the network or communications interface 822 may have a persistent communication connection.

Memory 824 in computer system 800 may include volatile memory and/or non-volatile memory (such as high-speed random access memory), including ROM, RAM, EPROM, EEPROM, flash, one or more smart cards, one or more magnetic disc storage devices, and/or one or more optical storage devices. Memory 824 may store an operating system 826, such as LINUX, UNIX, OS X, or WINDOWS, that includes procedures (or a set of instructions) for handling various basic system services for performing hardware dependent tasks. Memory 824 may also store procedures (or a set of instructions) in a network communications module 828. These communication procedures may be used for communicating with one or more computers and servers, including computers and/or servers that are remotely located with respect to computer system 800. Note that the communication procedures may include those for: a parallel interface, a serial interface, an infrared interface, Bluetooth, Firewire (IEEE 1394A and/or IEEE 1394B), and/or a USB interface (for example, USB-1 and/or USB-2 or High-Speed USB). Additionally, the communication procedures may include: HyperText Transport Protocol (HTTP) to transport information using the Transmission Control Protocol/Internet Protocol (TCP/IP), as well as a secure or encrypted version of HTTP, such as Hypertext Transport Protocol over Secure Socket Layer (HTTPS), a Layer 2 Tunneling Protocol (L2TP), or another Internet Protocol Security, such as IPSEC.

Memory 824 may include multiple program modules (or sets of instructions), including: a questionnaire module 830 (or a set of instructions), an encryption/decryption module 832 (or a set of instructions) (using, for example, pretty good privacy, symmetric encryption, and/or asymmetric encryption), and/or a statistical analysis module 834 (or a set of instructions). Note that one or more of these program modules (or sets of instructions) may constitute a computer-program mechanism.

During methods 100 (FIG. 1) and/or 400 (FIG. 4), questionnaire module 830 may provide questions 836 and associated answers 838 (which may be categorical) for display on one of displays 816. User selected answers 840 to these questions may be used to determine pattern of occurrence 842 corresponding to one or more episodic manifestations (or events) associated with a chronic disease and pattern of occurrence 844 corresponding to exposure (or consumption) of one or more potential triggers. Subsequently, statistical analysis module 834 may analyze pattern of occurrence 842 and 844 to identify one or more triggers 846.

As noted previously, while answering questions 836, additional questions 848 may be provided by questionnaire module 830 based on selected answers 840 to specify a causal relationship 850 between a given temporal onset that occurred in a time interval and exposure (or consumption) of a potential trigger (such as a food ingredient) during the same time interval. Alternatively, if the user reports that they consumed a particular dietary item 852, questionnaire module 830 may provide the user with a list of potential ingredients 854 in dietary item 852, thereby assisting the user in specifying what they ate.

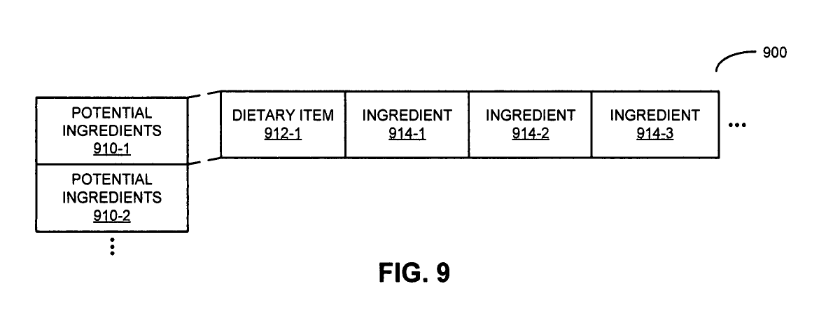

As shown in FIG. 9, which illustrates a data structure 900, list of potential ingredients 854 (FIG. 8) may be included in a computer-readable data structure. In particular, data structure 900 may include potential ingredients 910. For example, potential ingredients 910-1 may include: dietary item 912-1 and one or more selectable ingredients 914-1.

Referring back to FIG. 8, because information in computer system 800 may be sensitive in nature, in some embodiments at least some of the data stored in memory 824 and/or at least some of the data communicated using communication interface 822 is encrypted using encryption/decryption module 832.

Instructions in the various modules in memory 824 may be implemented in: a high-level procedural language, an object-oriented programming language, and/or in an assembly or machine language. Note that the programming language may be compiled or interpreted, e.g., configurable or configured, to be executed by the one or more processors 810.

Although computer system 800 is illustrated as having a number of discrete items, FIG. 8 is intended to be a functional description of the various features that may be present in computer system 800 rather than a structural schematic of the embodiments described herein. In practice, and as recognized by those of ordinary skill in the art, the functions of computer system 800 may be distributed over a large number of servers or computers, with various groups of the servers or computers performing particular subsets of the functions. In some embodiments, some or all of the functionality of computer system 800 may be implemented in one or more application-specific integrated circuits (ASICs) and/or one or more digital signal processors (DSPs).

Electronic devices, computers and servers in systems 700 (FIG. 7) and/or computer system 800 may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 712 (FIG. 7) may include: the Internet, World Wide Web (WWW), an intranet, a cellular-telephone network, LAN, WAN, MAN, or a combination of networks, or other technology enabling communication between computing systems.

User interface 300 (FIG. 3), user interface 600 (FIG. 6), system 700 (FIG. 7), computer system 800 and/or data structure 900 (FIG. 9) may include fewer components or additional components. Moreover, two or more components may be combined into a single component, and/or a position of one or more components may be changed. In some embodiments, the functionality of system 700 (FIG. 7) and/or computer system 800 may be implemented more in hardware and less in software, or less in hardware and more in software, as is known in the art.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the gen-eral principles defined herein may be applied to other embodiments and applications without departing from the spirit and scope of the present disclosure. Thus, the present disclosure is not intended to be limited to the embodiments shown, but is to be accorded the widest scope consistent with the principles and features disclosed herein.

What is claimed:

1. A computer-implemented method for collecting information associated with a chronic disease having episodic manifestations, the method comprising:
receiving information specifying an occurrence of a temporal onset of an episodic manifestation of the chronic disease in an individual during a time interval, wherein the time interval corresponds to a first temporal sampling rate;
using the computer, providing a question and associated categorical answers about exposure of the individual to a potential trigger of the episodic manifestation, wherein the categorical answers include time intervals corresponding to the first temporal sampling rate;
receiving an answer to the question, wherein the answer specifies at least one of the time intervals;
if the time interval and at least the one of the time intervals are the same, providing another question and additional associated categorical answers about the exposure of the individual to the potential trigger of the episodic manifestation, wherein the additional categorical answers include additional time intervals corresponding to a second temporal sampling rate within the time interval, and wherein the additional categorical answers specify a causal relationship between the exposure of the individual to the potential trigger of the episodic manifestation and the occurrence of the temporal onset of the episodic manifestation of the chronic disease in the individual; and
receiving another answer to the other question, wherein the other answer specifies at least one of the additional time intervals.

2. The method of claim 1, wherein the episodic manifestation includes at least one of: a type of headache, a seizure, dyspnea, increased pain, a reduction in mobility, cancer, a change in blood sugar level, use of an addictive substance, occurrence of mental illness, weight change, diarrhea, abdominal cramps, abdominal pain, arteriosclerosis, a heart attack, and change in renal function.

3. The method of claim 1, wherein the chronic disease includes at least one of migraine headache, tension headache, epilepsy, pulmonary disease, asthma, arthritis, cancer, diabetes, addiction, a psychiatric disorder, an eating disorder, gastrointestinal disease, cardiovascular disease, renal disease, and obesity.

4. The method of claim 1, wherein the time intervals include: morning, afternoon, evening and night.

5. The method of claim 1, wherein the first temporal sampling rate includes every 6 hours.

6. The method of claim 1, wherein the first temporal sampling rate is smaller than the second temporal sampling rate.

7. The method of claim 1, wherein the additional time intervals include: a time interval preceding the temporal onset; and a time interval after the temporal onset.

8. The method of claim 1, wherein the additional time intervals include: a time interval more than one hour preceding the temporal onset; a time interval less than one hour preceding the temporal onset; and a time interval after the temporal onset.

9. The method of claim 1, wherein the potential trigger of the episodic manifestation includes a neurological trigger that is neurologically sensed by the individual on a time scale within the time interval.

10. A computer-program product for use in conjunction with a computer system, the computer-program product comprising a non-transitory computer-readable storage medium and a computer-program mechanism embedded therein to collect information associated with a chronic disease having episodic manifestations, the computer-program mechanism including:
instructions for receiving information specifying an occurrence of a temporal onset of an episodic manifestation of the chronic disease in an individual during a time interval, wherein the time interval corresponds to a first temporal sampling rate;
instructions for providing a question and associated categorical answers about exposure of the individual to a potential trigger of the episodic manifestation, wherein the categorical answers include time intervals corresponding to the first temporal sampling rate;
instructions for receiving an answer to the question, wherein the answer specifies at least one of the time intervals;
if the time interval and at least the one of the time intervals are the same, instructions for providing another question and additional associated categorical answers about the exposure of the individual to the potential trigger of the episodic manifestation, wherein the additional categorical answers include additional time intervals corresponding to a second temporal sampling rate within the time interval, and wherein the additional categorical answers specify a causal relationship between the exposure of the individual to the potential trigger of the episodic manifestation and the occurrence of the temporal onset of the episodic manifestation of the chronic disease in the individual; and
instructions for receiving another answer to the other question, wherein the other answer specifies at least one of the additional time intervals.

11. The computer-program product of claim 10, wherein the episodic manifestation includes at least one of a type of headache, a seizure, dyspnea, increased pain, a reduction in mobility, cancer, a change in blood sugar level, use of an addictive substance, occurrence of mental illness, weight change, diarrhea, abdominal cramps, abdominal pain, arteriosclerosis, a heart attack, and change in renal function.

12. The computer-program product of claim 10, wherein the chronic disease includes at least one of migraine headache, tension headache, epilepsy, pulmonary disease, asthma, arthritis, cancer, diabetes, addiction, a psychiatric disorder, an eating disorder, gastrointestinal disease, cardiovascular disease, renal disease, and obesity.

13. The computer-program product of claim 10, wherein the time intervals include: morning, afternoon, evening and night.

14. The computer-program product of claim 10, wherein the first temporal sampling rate includes every 6 hours.

15. The computer-program product of claim 10, wherein the first temporal sampling rate is smaller than the second temporal sampling rate.

16. The computer-program product of claim 10, wherein the additional time intervals include: a time interval preceding the temporal onset; and a time interval after the temporal onset.

17. The computer-program product of claim 10, wherein the additional time intervals include: a time interval more than one hour preceding the temporal onset; a time interval less than one hour preceding the temporal onset; and a time interval after the temporal onset.

18. The computer-program product of claim 10, wherein the potential trigger of the episodic manifestation includes a neurological trigger that is neurologically sensed by the individual on a time scale within the time interval.

19. A computer system, comprising:
a processor;
memory; and
a program module, wherein the program module is stored in the memory and configurable to be executed by the processor to collect information associated with a chronic disease having episodic manifestations, the program module including:
instructions for receiving information specifying an occurrence of a temporal onset of an episodic manifestation of the chronic disease in an individual during a time interval, wherein the time interval corresponds to a first temporal sampling rate;
instructions for providing a question and associated categorical answers about exposure of the individual to a potential trigger of the episodic manifestation, wherein the categorical answers include time intervals corresponding to the first temporal sampling rate;
instructions for receiving an answer to the question, wherein the answer specifies at least one of the time intervals;
if the time interval and at least the one of the time intervals are the same, instructions for providing another question and additional associated categorical answers about the exposure of the individual to the potential trigger of the episodic manifestation, wherein the additional categorical answers include additional time intervals corresponding to a second temporal sampling rate within the time interval, and wherein the additional categorical answers specify a causal relationship between the exposure of the individual to the potential trigger of the episodic manifestation and the occurrence of the temporal onset of the episodic manifestation of the chronic disease in the individual; and
instructions for receiving another answer to the other question, wherein the other answer specifies at least one of the additional time intervals.

20. The computer system of claim 19, wherein the potential trigger of the episodic manifestation includes a neurological trigger that is neurologically sensed by the individual on a time scale within the time interval.
